(19) United States
(12) Patent Application Publication
(10) Pub. No.: US 2024/0102502 A1
(43) Pub. Date: Mar. 28, 2024

(54) QUICK ASSEMBLY FURNITURE

(71) Applicant: ZHEJIANG ELEPHANT SPORT CO., LTD., JIASHAN (CN)

(72) Inventor: Jerry TSAI, TAICHUNG CITY (TW)

(21) Appl. No.: 17/953,621

(22) Filed: Sep. 27, 2022

(51) Int. Cl. F16B 12/10; A47B 5/02; A47B 47/00; A47C 4/02; A47C 19/00

(52) U.S. Cl. CPC F16B 12/10; A47B 5/02; A47B 47/0075; A47C 4/02; A47C 19/005; F16B 2012/106

(57) ABSTRACT

A quick assembly furniture is provided and comprises at least three slabs, each of the slabs has two surfaces and at least three edges, the slabs are linked to each other, the edges of one of the slabs are linked to the surfaces of others so as to form a three-dimensional configuration; and a plurality of assembly units, respectively including a positioning pin and an assembly groove; wherein during assembly, the positioning pins are clamped and fixed within the assembly groove. The disassembly and assembly of the furniture can be quickly completed without the use of tools.

### FIELD OF THE INVENTION

The present invention relates to a furniture, and more particularly to a quick assembly furniture capable for quick assembly without the use of tools.

### BACKGROUND OF THE INVENTION

Whether it is at home, office or outdoors, furniture will be used to construct a fixed spatial position, such as tables, chairs, cabinets and other furniture, through various furniture to produce different functions, such as arranging, receiving objects or sitting.

Most of the general furniture has two types, one of them is that has been assembled and fixed, and the other one is that needs to be assembled after purchase; when the furniture has been fixed, it takes up more space for stocked and transported, and it will be inconvenient to transport. Besides, the furniture that needs to be assembled, although the process of inventory and transportation is relatively simple and does not take up space, however, because screwdrivers are needed to fix the assembled bolts and other various tools for assembly during the assembly process, the screws at each assembly position may have differences in size and specifications, which may cause assembly difficulties, or the screw position is not easy to align Additionally, when the assembled furniture is disassembled, reaming or dimensional changes are likely to occur in the assembled position, which leads to the instability of the assembled furniture during the reassembly procedure.

### SUMMARY OF THE INVENTION

An object of this present invention is to provide a quick assembly furniture that can be assembled without tools.

Another object of this present invention is to provide a quick assembly furniture, which can be disassembled and assembled for many times without affecting the assembly precision and assembly position.

To achieve above objects, the present invention provides a quick assembly furniture that comprises:
at least three slabs, each of the slabs being in board-shape, has two surfaces and at least three edges, the slabs are linked to each other, the edges of one of the slabs are linked to the surfaces of others so as to form a three-dimensional configuration; and
a plurality of assembly units, correspondingly disposed at connection positions of the surfaces and the edges of the slabs, the assembly units respectively include a positioning pin and an assembly groove;
wherein the positioning pins are installed in the slabs and a knob is convexly arranged at an end of each of the positioning pins which is protruded from the corresponding slab; and
wherein a sliding rail is arranged at a end surface of the assembly groove, the sliding rail has a large diameter portion and a small diameter portion, a width of the large diameter portion is larger than a diameter of the knob, a width of the small diameter portion is smaller than the diameter of the knob of the positioning pin, the positioning pin moves toward the small diameter portion after the knob of the positioning pin is installed from the large diameter portion to the sliding rail, so that the knob is limited in the sliding rail and then the slabs are assembled and fastened onto another.

The quick assembly furniture of the present invention, when the slabs are assembled with each other, they are fixed by the assembly units. The assembly units are penetrated in the sliding rail through the positioning pins to form a limiting and fixing state. The entire installation process does not require the use of tools, and the installation is very fast and convenient. After installation and positioning, the assembly is completed and there is no installation deviation. Furthermore, when the furniture is disassembled, the positioning pin is moved out of the sliding rail, which will not affect the entire structure, and there will be no issue of loosening after repeated installation with many times.

### BRIEF DESCRIPTION OF THE DRAWINGS

In order to enable the examiners to further understand the purpose, characteristics and effects of the present invention, the following four preferred embodiments are listed below and described in detail with the drawings, among which:

FIG. 1 is a perspective view of a quick assembly table to a preferred embodiment of the present invention.

FIG. 2 is an exploded perspective view of a spread-out state of the quick assembly table according to the preferred embodiment of the invention.

FIG. 3 is an exploded perspective view of an assembled state of the quick assembly table according to the preferred embodiment of the invention.

FIG. 4 is an exploded perspective view which is viewed from a different angle compared to FIG. 3.

FIG. 5 is a schematic diagram of an installation position of the assembly unit of the lateral-side slabs.

FIG. 6 is a schematic diagram of an installation position of the assembly unit of the longitudinal-side slabs.

FIG. 7 is a schematic diagram of an installation position of the assembly unit of the top-side slab.

FIG. 8 is a schematic diagram of an assembly position of the assembly unit.

FIG. 9 is a schematic cross-sectional view of the assembly unit.

FIG. 10 is a schematic longitudinal cross-sectional view of the assembly unit.

FIG. 11 is a schematic view of the assembly of the lateral-side slabs on both sides of the intermediate slab.

FIG. 12 is a schematic diagram of the assembly of the longitudinal-side slabs on both sides of the lateral-side slabs.

FIG. 13 is a schematic diagram of the assembly of the top-side slab on the tops of the longitudinal-side slabs.

FIG. 14 is a perspective view of a second preferred embodiment of the present invention.

FIG. 15 is an assembly schematic diagram of a third preferred embodiment of the present invention.

FIG. 16 is an assembly schematic diagram of a fourth preferred embodiment of the present invention.

### DESCRIPTION OF THE PREFERRED EMBODIMENT

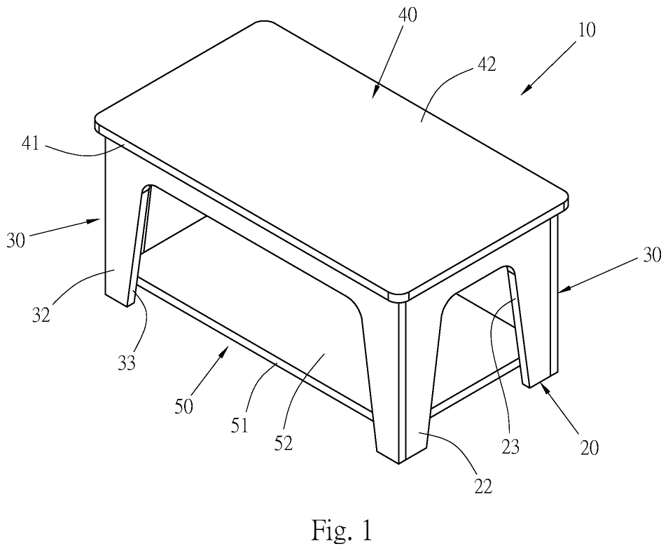

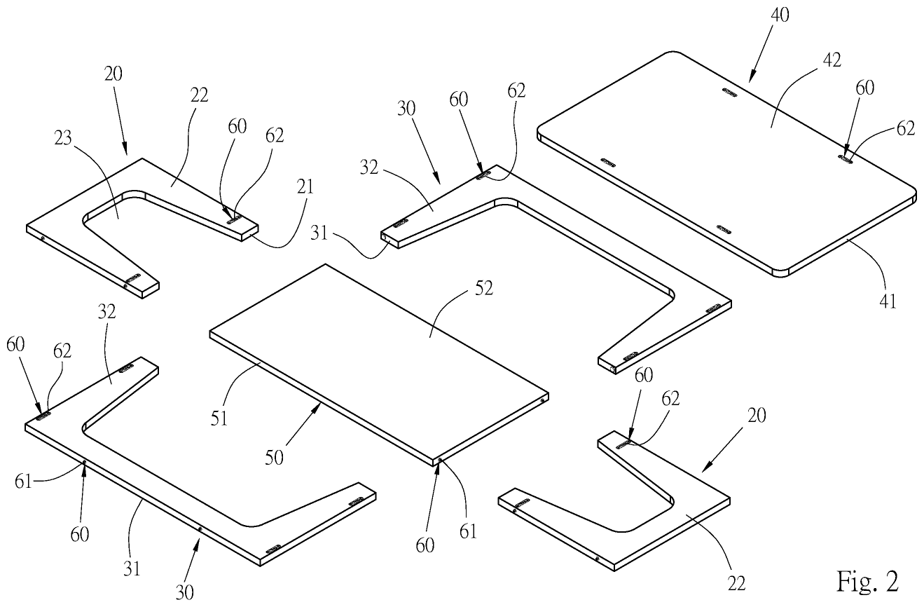

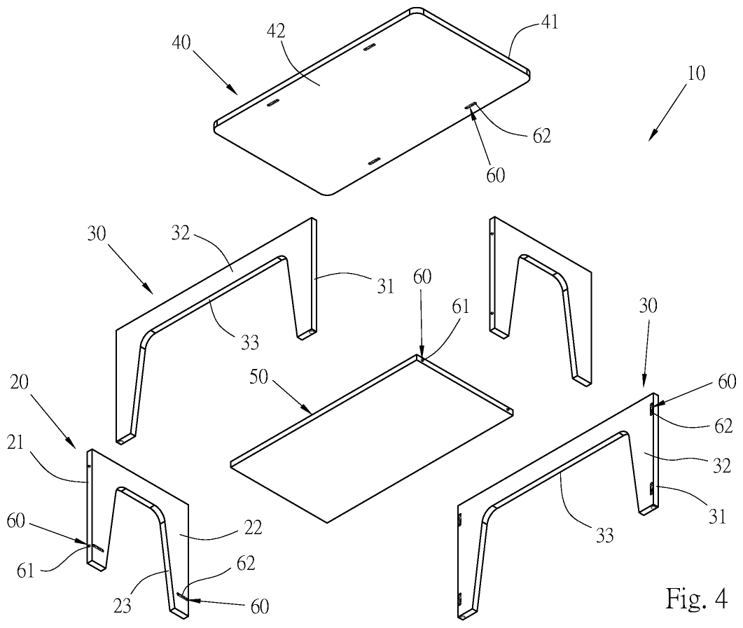

Please refer to FIGS. 1 to 4, which provide one preferred embodiment of a quick assembly furniture, the embodiment is a quick assembly table 10. The quick assembly furniture includes six slab.

The six slabs are composed of two lateral-side slabs 20, two longitudinal-side slabs 30, a top-side slab 40 and an intermediate slab 50. The two lateral-side slabs 20 and the two longitudinal-side slabs 30 are linked to each other to form a quadrangle. In this embodiment, the quadrangle is a rectangle, but it can also be set as a square, or other polygonal shapes assembled by a plurality of slabs. The intermediate slab 50 is arranged at a center of the two lateral-side slabs 20 and the two longitudinal-side slabs 30. The topside slab 40 is arranged at top of the lateral-side slabs 20 and the two longitudinal-side slabs 30. They are assembled and formed a table configuration. These slabs can also be used to make furniture such as chairs, cabinets, beds, dining tables, dining chairs, etc., according to different manufacturing requirements or designs. The two lateral-side slabs 20, the two longitudinal-side slabs 30, the top-side slab 40 and the intermediate slab 50 are fixed by several assembly units 60. The assembly positions and installation methods of the assembly units 60 will be described below.

Each of the assembly units 60 includes a positioning pin 61 and a assembly groove 62. One end of the positioning pin 61 has a thread 611. A positioning plate 612 is arranged convexly around the positioning pin 61 and at the side of the thread 611. The thread 611 can be screwed into the slabs, and the positioning can be completed after the positioning plate 612 is pressed against the slabs. A knob 613 is arranged at the other end of positioning pin 61 opposite to the thread 611. A positioning block 621 is protruded from both sides of the assembly groove 62. A cover plate 622 is covered on the assembly groove 62, and the cover plate 622 is disposed on the positioning block 621, so that a space is reserved between the cover plate 622 and the assembly groove 62. A sliding rail 623 is penetrated through the cove plate 622. The sliding rail 623 has a large diameter portion 624 and small diameter portion 625. A width of the large diameter portion 624 is larger than a diameter of the knob 613 for providing the knob 613 to install in or move out. A width of the small diameter portion 625 is smaller than a diameter of the knob 613 for clamping the knob 613. When assembling, the knob 613 of the positioning pin 61 is placed into the assembly groove 62 from the large diameter portion 624, and moves toward the small diameter portion 625 so that the knob 613 is limited in the small diameter portion 625 to form a fixation.

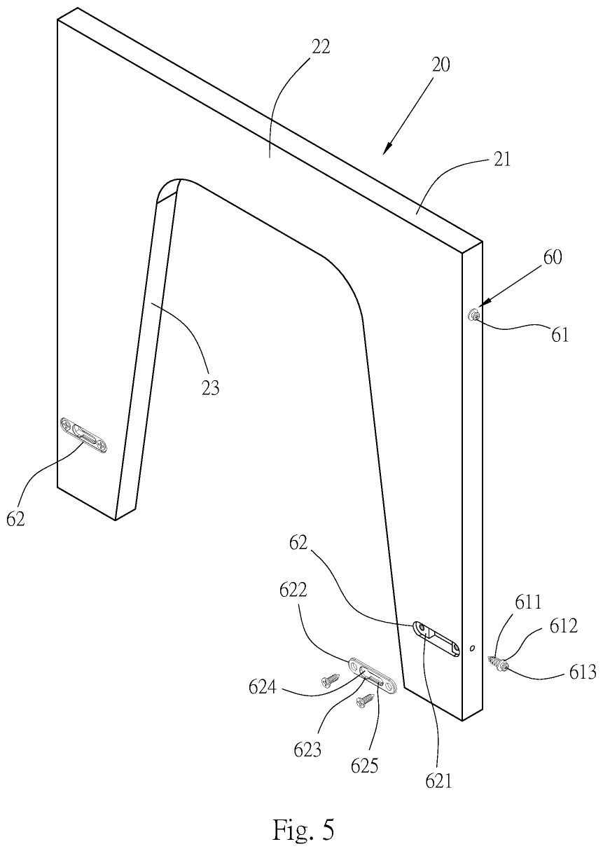

Each of the two lateral-side slabs 20, please also refer to FIG. 5, is a quadrangle with four edges 21 and two surfaces 22, and a window 23 is formed to penetrate through the center of the bottom of the lateral-side slab 20. Two assembly grooves 62 are disposed at intervals on one surface 22 of the lateral-side slab 20 near the bottom. The two edges 21 of the lateral-side slab 20 are respectively provided with one positioning pin 61 up and down.

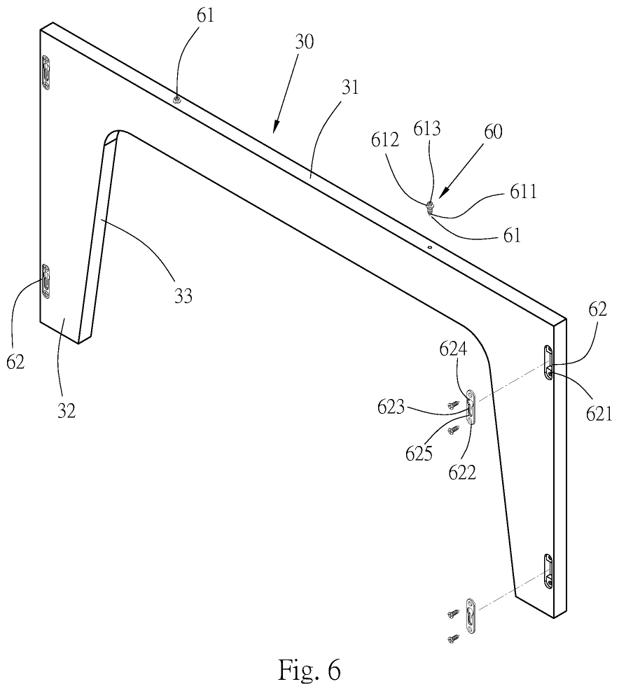

Each of the two longitudinal-side slabs 30, please also refer to FIG. 6, is a quadrangle with four edges 31 and two surfaces 32, and a window 33 is formed to penetrate through the center of the bottom of the longitudinal-side slab 30. One surface 32 of the longitudinal-side slabs 30 is in contact with the two lateral-side slabs 20, and two assembly grooves 62 are respectively provided at the contact positions of the lateral-side slabs 20 and the two longitudinal-side slabs 30 are connected with the positioning pins 61 arranged at the edges 21 of the two lateral-side slabs 20. Two positioning pins 61 are at intervals arranged and respectively disposed on the top of the edges 31 of the two longitudinal-side slabs 30.

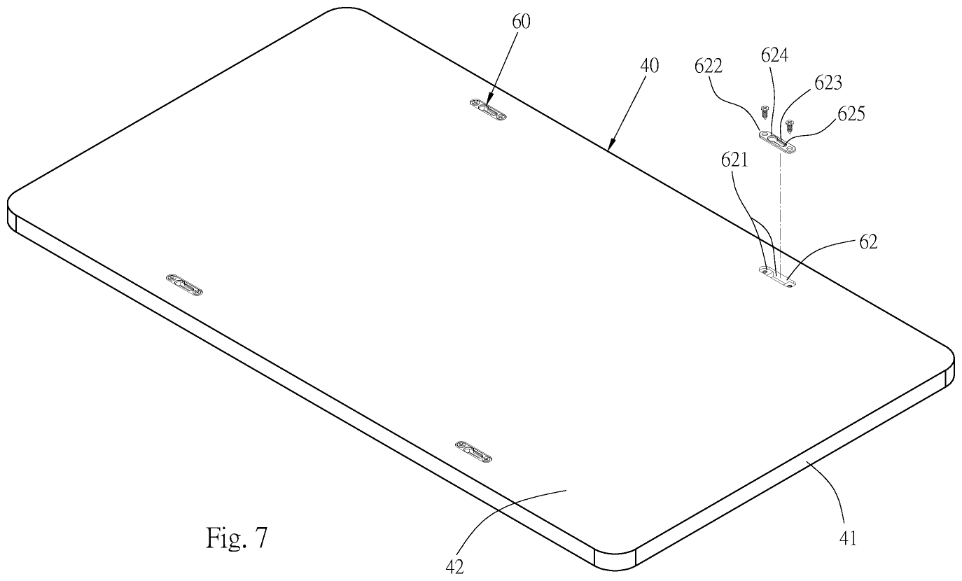

The top-side slab 40, please refer to FIG. 7, is a quadrangle with four edges 41 and two surfaces 42. Four assembly grooves 62 are arranged at the bottoms of the surfaces 42 of the top-side slab 40 in correspondence to the positioning pins 61 of the two longitudinal-side slabs 30.

The intermediate slab 50 is a quadrangle with four edges 51 and two surfaces 52. Two positioning pins 61 are respectively provided on the front and rear edges 51 of the intermediate slab 50 in correspondence to the assembly grooves 62 on the surfaces 22 of the two lateral-side slabs 20.

The number and positions of the above-mentioned slabs and the assembly units are not limited, and can be changed with different designs. The following will briefly describe the assembling process of the table 10.

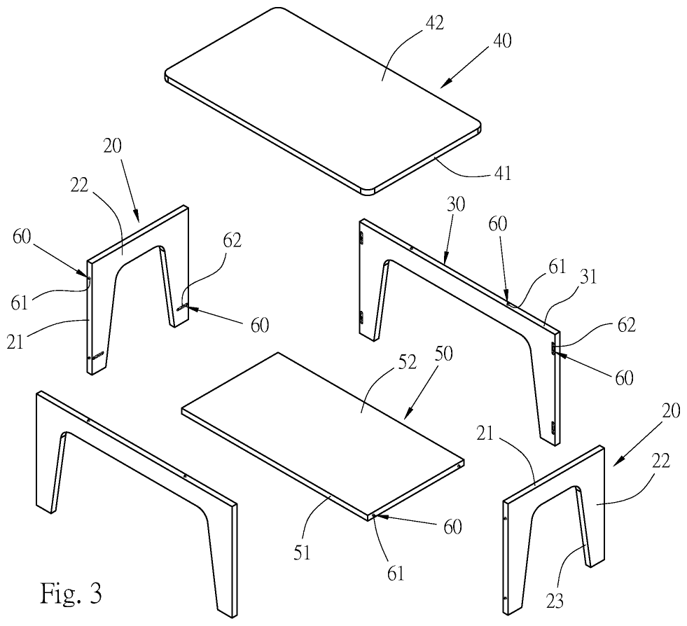

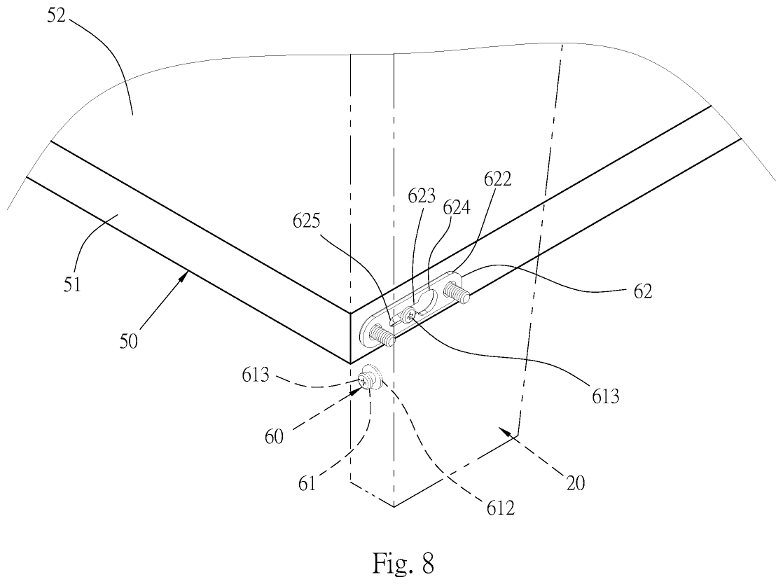

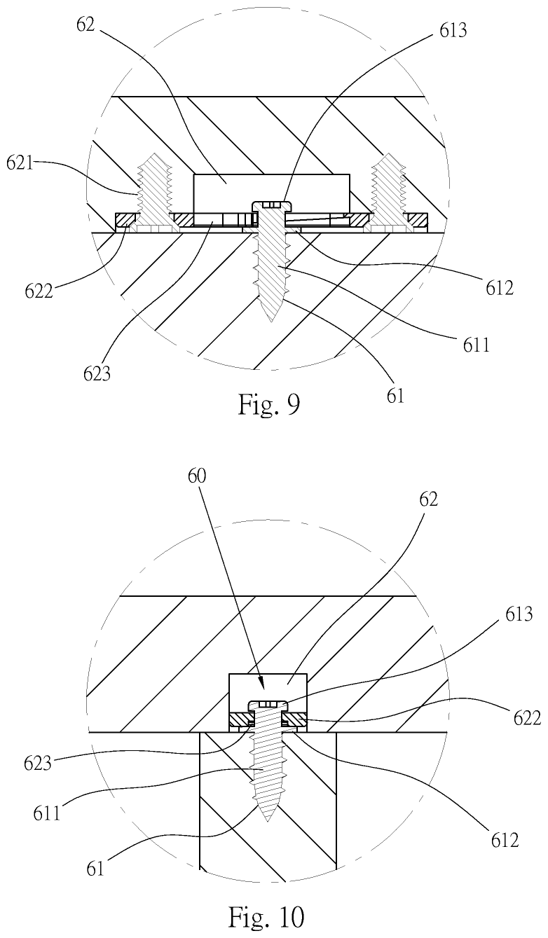

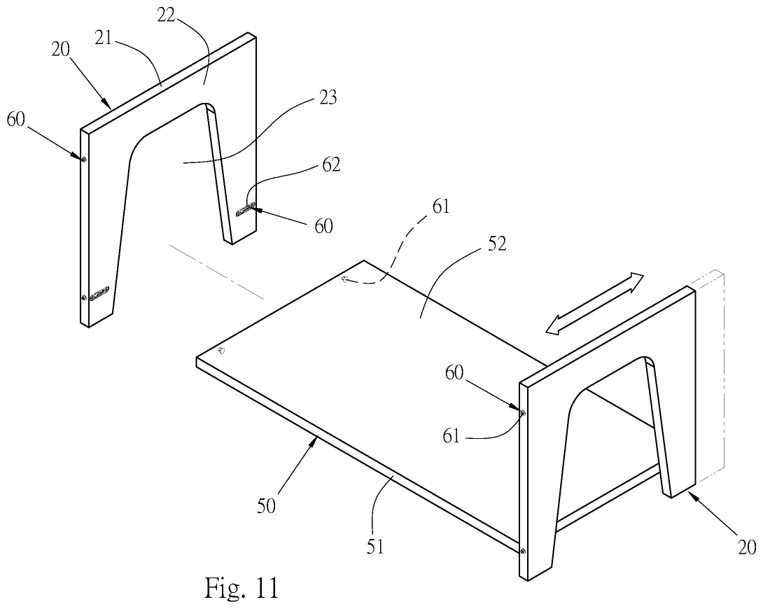

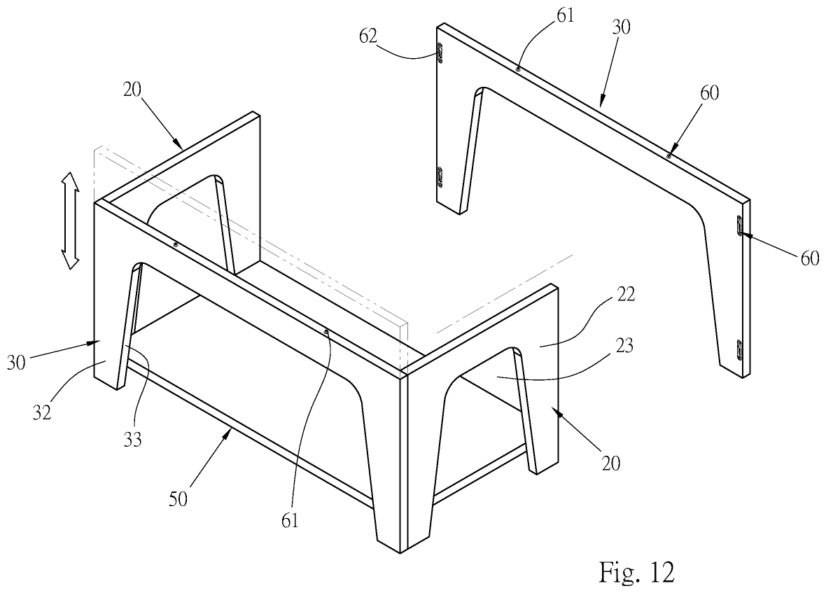

Please refer to FIGS. 3 to 4 and FIGS. 8 to 13, when assembling, please refer to FIG. 11, firstly the two lateral-side slabs 20 and the intermediate slab 50 are linked to each other. The two lateral-side slabs 20 are arranged on the front and rear sides of the intermediate slab 50, and the assembly grooves 62 of the surfaces 22 of the two lateral-side slabs 20 are aligned with the positioning pins 61 of the intermediate slab 50. The knobs 613 of the positioning pins 61 are inserted into the large diameter portion 624 of the sliding rail 623 of the cover plate 622. Next, when the two lateral-side slabs 20 are pushed, the knobs 613 of the positioning pins 61 of the intermediate slab 50 are moved toward the direction of the small diameter portion 625 of the sliding rails 623 and moved laterally, so that the intermediate slab 50 can be moved. And then, the positioning pins 61 can be limited in the assembly grooves 62 of the two lateral-side slabs 20.

Next, please refer to FIG. 12, the two longitudinal-side slabs 30 are arranged on both sides of the two lateral-side slabs 20, that is, the left and right sides of the intermediate slab 50, so that two lateral-side slabs 20 and the intermediate slab 50 can be sandwiched between the two longitudinal-side slabs 30. The surface 32 having the assembly groove 62 faces the edge 21 of the two lateral-side slabs 20 having the positioning pins 61, and the positioning pins 61 arranged on the two lateral-side slabs 20 are inserted into the large diameter part 624 of the sliding rails 623 of the two longitudinal-side slabs 30. Next, the two longitudinal-side slabs 30 are pushed upward, so that the sliding rails 623 on the cover slab 622 arranged on the longitudinal-side slab 30 can be moved from the large diameter portion 624 to the small diameter portion 625. When the two longitudinal-side slabs 30 are assembled and fixed on the two sides of the two lateral-side slabs 20, the two longitudinal-side slabs 30 will limit the lateral movement of the intermediate slab 50 and the two lateral-side slabs 20, so that the intermediate slab 50 and the two lateral-side slabs 20 are limited by the two longitudinal-side slabs 30 and will not be separated.

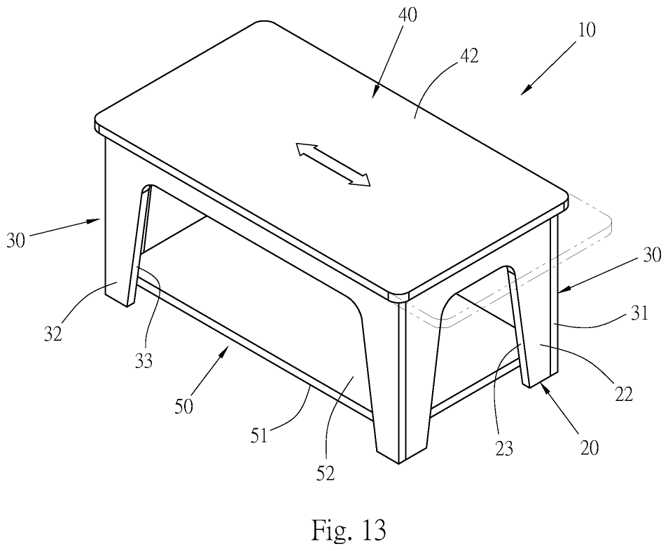

Finally, please refer to FIG. 13, the top-side slab 40 is arranged and covers on the top side of the two lateral-side slabs 20 and the two longitudinal-side slabs 30. After passing the positioning pins 61 at the top of the two longitudinal-side slabs 30 through the sliding rails 623 on the cover plate 622 of the assembly groove 62 of the surface 42 of the top-side slab 40, push the top-side slab 40. The knobs 613 arranged on the positioning pins 61 on the two longitudinal-side slabs 30 can be moved from the direction of the large diameter portion 624 of the sliding rail 623 of the top-side slab 40 to the direction of the small diameter portion 625, so that the knobs 613 arranged on the two longitudinal-side slabs 30 can limit the top-side slab 40. The top-side slab 40 is limited by the two lateral-side slabs 20, so that the two longitudinal-side slabs 30 can not be pulled down and separated and then the two longitudinal-side slabs 30 are limited. In this way, the installation can be completed without tools, and the separation of the assembled slabs can be avoided through the restriction of the moving direction.

When disassembling, please refer to FIG. 13, push the top-side slab first, so that the positioning pin 61 at the top of the longitudinal-side slab can move from the small diameter part 625 to the large diameter part 624. The knob 613 of the positioning pin 61 can be removed from the assembly groove 62, so that the top-side slab 40 can be separated from the two longitudinal-side slabs 30. Next, referring to FIG. 12, the two longitudinal-side slabs 30 are pushed down respectively, so that the positioning pins 61 arranged on the sides of the two lateral-side slabs 20 can be moved to the position of the large diameter portion 624 of the assembly groove 62 arranged on the edge 32 of the two longitudinal-side slabs 30 and the two longitudinal-side slabs 30 can be relatively separated. Next, as shown in FIG. 11, push the two lateral-side slabs 20 to the side, so that the two lateral-side slabs 20 and the intermediate slab 50 can be separated and these slabs can be separated into a single-piece structure. At the same time, because the assembly between the assembly units 60 is fixed by means of sliding limit, the fixing action can be completed without the use of tools. In addition, there is no deformation or attrition between the positioning pins 61 and the assembly grooves 62. Therefore, when the assembly units 60 are being clamped and limited again, the assembly units 60 can still achieve a good fixing effect, and the fixing effect will not be influenced by repeated disassembly and assembly.

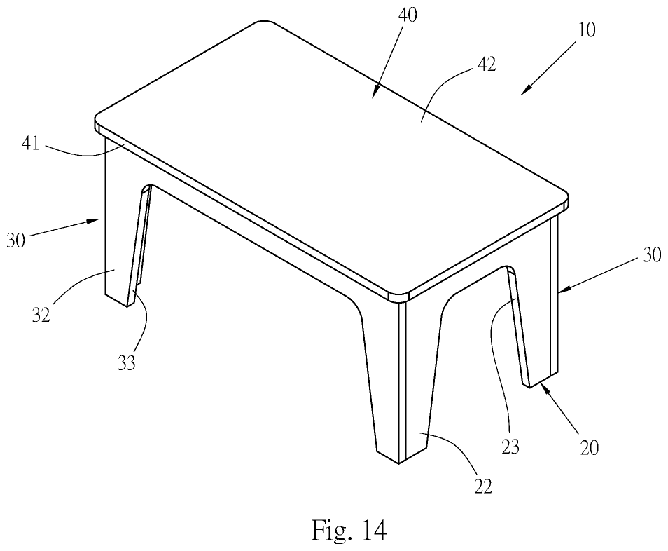

In addition, please refer to FIG. 14, the table can also omit the arrangement of the intermediate slab 50, and the two longitudinal-side slabs are combined with the sides of the two lateral-side slabs 20. And the top-side slab 40 is assembled on the top of the two longitudinal-side slabs 30 and the two lateral-side slabs 20 to complete the assembly.

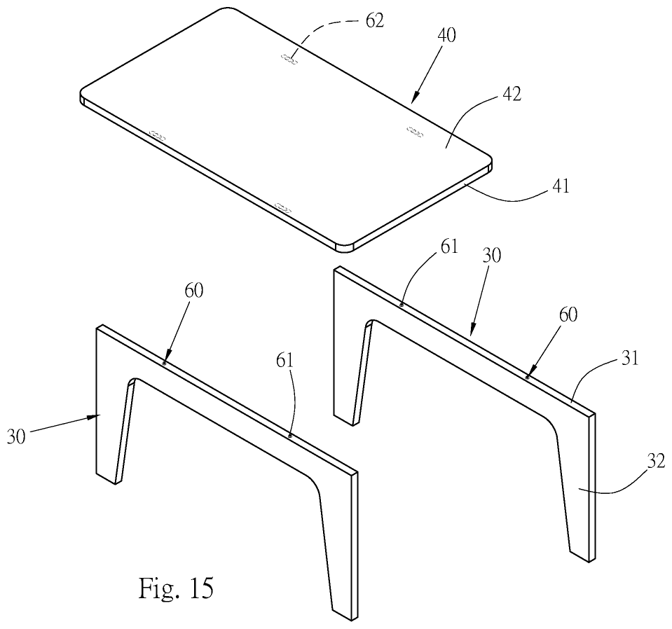

Please refer to FIG. 15, which is the assembly furniture of the third preferred embodiment provided by this present invention. Its main structure is the same as that of the previous embodiment, and the same structure is represented by the same reference numerals, and will not be described in detail.

The assembly furniture is a chair and composed of two longitudinal-side slabs 30 and a top-side slab 40. The two longitudinal-side slabs 30 are uprightly arranged and spaced apart with a distance. The assembly units 60 are disposed on edges 31 on the top side of the two longitudinal-side slabs 30 and the edges 41 on bottom side of the top-side slab 40. The edges 31 on top side of the two longitudinal-side slabs 30 are respectively provided with two positioning pins 61, and the surfaces 42 on bottom side of the top-side slab 40 are provided with four assembly grooves 62. The edges 31 on top side of the two longitudinal-side slabs 30 are assembled in the assembly grooves 62 of the edges 41 on the bottom side of the top-side slab 40 by the positioning pins 61, so that a chair with an inverted U-shaped structure is formed between the two longitudinal-side slabs 30 and the top-side slab 40. If the strength of the chair is to be increased, a reinforcing member (e.g. The arrangement of the intermediate slab) can be disposed laterally between the two longitudinal-side slabs 30 to avoid the position change between the two longitudinal-side slabs 30.

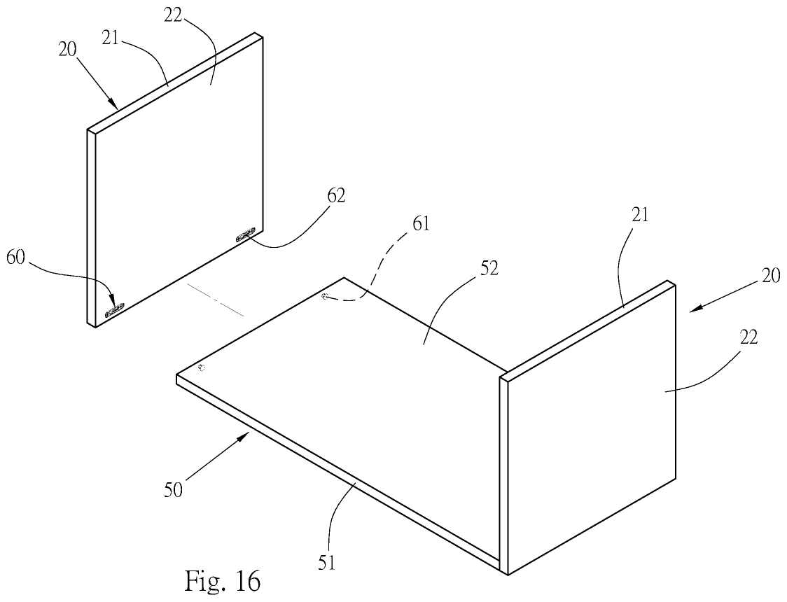

Please refer to FIG. 16, which is the assembly furniture of the fourth preferred embodiment provided by this present invention. Its main structure is the same as that of the first preferred embodiment, and the same structure is represented by the same reference numerals, and will not be described in detail.

The assembly furniture is a cabinet and composed of two lateral-side slabs 20 and an intermediate slab 50. The two lateral-side slabs 20 are uprightly arranged and space apart with a distance. The surfaces 22 at opposite side of the two lateral-side slabs 20 and the two edges 51 of the intermediate slab 50 are provided with a plurality of assembly units 60. The two edges 51 of the intermediate slab 50 are respectively provided with two positioning pins 61, and the surfaces 22 at opposite side of the two lateral-side slabs 20 are provided with the two assembly grooves 62. The intermediate slab 50 is installed in the two assembly grooves 62 of the two lateral-side slabs 20 with the positioning pins 61 of the two edges 51 facing each other, so that these slabs form an inverted U-shaped structure, which can hold objects. In order to increase the structural strength of the cabinet, a reinforcing member (such as the arrangement of the longitudinal-side slabs) can also be provided on one side or the open sides of the two lateral-side slabs 20 to avoid the position or force deformation between the two lateral-side slabs 20.

The above-mentioned embodiments are merely used to illustrate the technical ideas and features of the invention, they are not intended to limit the claims of the invention, and all other equivalent changes and modifications completed based on the technical means disclosed in the invention should be included in the claims covered by the invention.

What is claimed is:

1. A quick assembly furniture, comprising:
at least three slabs, each of the slabs has two surfaces and at least three edges, the slabs are linked to each other, the edges of one of the slabs are linked to the surfaces of others so as to form a three-dimensional configuration; and
a plurality of assembly units, correspondingly disposed at connection positions of the surfaces and the edges of the slabs, the assembly units respectively include a positioning pin and an assembly groove;
wherein the positioning pins are installed in the slabs and a knob is convexly arranged at an end of each of the positioning pins which is protruded from the corresponding slab; and
wherein a sliding rail is arranged at a surface of the assembly groove, the sliding rail has a large diameter portion and a small diameter portion, a width of the large diameter portion is larger than a diameter of the knob, a width of the small diameter portion is smaller than the diameter of the knob of the positioning pin, the positioning pin moves toward the small diameter portion after the end of the positioning pin is installed from the large diameter portion to the sliding rail, so that the knob is limited in the sliding rail and then the slabs are assembled and fastened onto another.

2. The quick assembly furniture as claimed in claim 1, wherein the positioning pin of each of the assembly unit includes a thread, and the positioning pin is screwed in the slabs with the thread.

3. The quick assembly furniture as claimed in claim 1, wherein a positioning plate is arranged convexly around the positioning pin, and the positioning slab is abutted against on the slab.

4. The quick assembly furniture as claimed in claim 2, wherein a positioning plate is arranged convexly around the positioning pin, and the positioning slab is abutted against on the slab.

5. The quick assembly furniture as claimed in claim 1, wherein each of the positioning pins of the assembly unit is arranged at the edges of the slabs, and each of the assembly grooves of the assembly units is arranged opposite to the surface of the slab.

6. The quick assembly furniture as claimed in claim 1, wherein a cover plate is arranged on the assembly groove of the assembly unit, and the sliding rail is arranged at the cover plate.

7. The quick assembly furniture as claimed in claim 6, wherein a positioning block is convexly arranged at two side of the assembly groove, and the cover plate is arranged on the positioning block so that a space is formed between the cover plate and the assembly groove to receive the knob.

8. The quick assembly furniture as claimed in claim 1, wherein the slabs are formed any one of tables, chairs, cabinets, beds, dining tables and dining chairs.

9. The quick assembly furniture as claimed in claim 1, wherein the slabs with a later assembly sequence are arranged in a direction of a disassembling position of the slabs with an earlier assembly sequence to form a limit.

10. The quick assembly furniture as claimed in claim 1, wherein two longitudinal-side slabs spaced apart with a distance, the positioning pins of the assembly units are arranged at the edge on top side of the two longitudinal-side slabs, a top-side slab covers on the two slabs, the surface of the top-side slab is provided with the assembly groove corresponding to the positioning pin so that the top-side slab is able to be assembled above the two slabs.

11. The quick assembly furniture as claimed in claim 1, wherein two lateral-side slabs are spaced apart with a distance, the assembly grooves of the assembly units are arranged at the surfaces on opposite side of the two slabs, one intermediate slab is laterally arranged between the two lateral-side slabs, two edges of the intermediate slab are provided with the positioning pins corresponding to the assembly grooves so that the intermediate slab is able to be assembled between the two later-side slabs.

12. The quick assembly furniture as claimed in claim 1, wherein five slabs comprising two lateral-side slabs, two longitudinal-side slabs and a top-side slab; the two lateral-side slabs are arranged upright at intervals; the two longitudinal-side slabs are arranged at two sides of the two lateral-side slabs, the two longitudinal-side slabs are slid up and down and assembled to the side surfaces of the two lateral-side slabs by the assembly units; the top-side slab is arranged at tops of the two lateral-side slabs and the two longitudinal-side slabs, the side surface of the top-side slab is slid back and forth and combined with the edges of the two longitudinal-side slabs by the assembly units.

13. The quick assembly furniture as claimed in claim 12, further comprising an intermediate slab with a flat arrangement, the surfaces of the two lateral-side slabs are laterally slid and combined with the edges of the intermediate slab by the assembly units.
